(19) United States
(12) Patent Application Publication
(10) Pub. No.: US 2010/0114910 A1
(43) Pub. Date: May 6, 2010

(54) Blog search apparatus and method using blog authority estimation

(75) Inventors: Dongman Lee, Daejeon (KR); Yoonjae Jeong, Seoul (KR)

Correspondence Address: BACON & THOMAS, PLLC, 625 SLATERS LANE, FOURTH FLOOR, ALEXANDRIA, VA, 22314-1176, US

(73) Assignee: KOREA ADVANCED INSTITUTE OF SCIENCE AND TECHNOLOGY, Daejon (KR)

(21) Appl. No.: 12/385,807

(22) Filed: Apr. 21, 2009

(30) Foreign Application Priority Data
Oct. 27, 2008 (KR) 10-2008-0105495
Mar. 31, 2009 (KR) 10-2009-0027594

(51) Int. Cl. G06F 17/30

(52) U.S. Cl. 707/748; 707/E17.014

(57) ABSTRACT

A blog search method includes estimating authority scores of target blogs to be searched by using local information about the target blogs; calculating priorities of the target blogs based on the authority scores and the presence of documents satisfying a query; and sequentially searching the target blogs based on the priorities. The authority scores is estimated by using at least one of the number of neighboring blogs linked via trackbacks and the number of neighboring blogs linked via comments as the local information.

### FIELD OF THE INVENTION

The present invention relates to a blog search apparatus and method using blog authority estimation, and, more particularly, to a blog search apparatus and method using blog authority estimation for sequentially searching target blogs according to priorities calculated depending on estimated authority scores for the target blogs and the presence of documents corresponding to a query.

### BACKGROUND OF THE INVENTION

Blog is a new type of medium which has recently been popularized. Such a blog is a kind of web page, and has a feature of strengthened social networks. Accordingly, a search between users linked to each other through blogs is an important factor. Methods for a search between linked blogs may include an egocentric search method and a centralized search method.

The egocentric search method aims to search for desired documents satisfying to user's needs to retrieve documents included in blogs linked to the user's blog. However, such egocentric search method is disadvantageous in that, it takes long time to search for important documents when a large number of blogs exists in the user's blog network. Further, since the retrieved documents are not aligned pursuant to an importance level of the documents, it is difficult to find out which documents are important documents satisfying the user's needs.

In contrast, the centralized web search method is advantageous in that all documents in blogs are collected and ranked to obtain search results aligned pursuant to the importance level which corresponds to a user's query. Since, however, highly ranked results occupy only a small part of the entire blogs and are limited to very popular documents in the entire blogs, the search results may not satisfy individual users' needs.

### SUMMARY OF THE INVENTION

In view of the above, the present invention provides a blog search method and apparatus using blog authority estimation which combines an advantage of a centralized web search method with an egocentric search method, thereby improving a speed of egocentric search and a quality of egocentric search results.

In accordance with an aspect of the present invention, there is provided a blog search method including: estimating authority scores of target blogs to be searched by using local information about the target blogs; calculating priorities of the target blogs based on the authority scores and the presence of documents satisfying a query; and sequentially searching the target blogs based on the priorities.

In said estimating the authority scores, the authority scores may be estimated by using an estimation function with respect to normalized real authority scores.

The estimation function may be a heuristic function.

The local information may include at least one of the number of neighboring blogs linked via trackbacks and the number of neighboring blogs linked via comments.

In said estimating the authority score, in order to estimate authority scores of the target blogs calculated based on data of all target blogs by using an EigenRumor algorithm, weights may be calculated and used depending on the number of neighboring blogs linked via trackbacks and the number of neighboring blogs linked via comments through linear regression analysis.

Said calculating the priorities may include assigning weights to the authority scores when a document satisfying the query is present.

Said sequentially searching the target blogs may include searching blogs falling within a preset search range from among all the target blogs.

The preset search range may be at least one of a range of distance from a user's blog and a range of the number of blogs to be searched.

The target blogs falling within the preset search range are preferably searched by sequentially visiting the blogs in a greedy search manner.

In accordance with another aspect of the present invention, there is provided a blog search apparatus including a estimation unit for estimating authority scores of target blogs to be searched by using local information about the blogs; a priority calculation unit for calculating priorities depending on the authority scores and the presence of documents satisfying a query; and a blog search unit for sequentially searching the target blogs based on the priorities.

The authority estimation unit may estimate the authority scores by using an estimation function with respect to normalized real authority scores.

The estimation function may include a heuristic function.

The local information may include at least one of the number of neighboring blogs linked via trackbacks and the number of neighboring blogs linked via comments as the local information.

In the authority estimation unit, in order to estimate authority scores of the target blogs calculated based on data of all target blogs by using an EigenRumor algorithm and calculates, weights may be calculated and used depending on the number of neighboring blogs linked via trackbacks and the number of neighboring blogs linked via comments through linear regression analysis.

The priority calculation unit may assign weights to the authority scores when a document satisfying the query is present.

The blog search unit may search blogs falling within a preset search range from among all the target blogs.

The preset search range may be at least one of a range of distance from a user's blog and a range of the number of blogs to be searched.

The blog search unit may search the blogs falling within the preset search range by sequentially visiting the blogs in a greedy search manner.

### BRIEF DESCRIPTION OF THE DRAWINGS

The objects and features of the present invention will become apparent from the following description of preferred embodiments given in conjunction with the accompanying drawings, in which:

FIG. 1 is a block diagram of a blog search apparatus using blog authority estimation in accordance with the present invention;

FIG. 2 is a flowchart of a blog search method using blog authority estimation in accordance with the present invention;

FIG. 3 is a conceptual diagram of blog authority scores used in the present invention;

FIGS. 4a to 4c are graphs showing the distribution of blog authority scores used in the present invention;

FIG. 5 is a conceptual diagram showing a blog search process performed by the blog search apparatus shown in FIG. 2; and

FIG. 6 is an algorithm written to execute, on a computer, the blog search method of present invention.

### DETAILED DESCRIPTION OF THE EMBODIMENTS

Hereinafter, the embodiments of the present invention will be described in detail with reference to the accompanying drawings which for a part hereof. Further, in the description of the present invention, it should be noted that, if it is determined that a detailed description of well-known functions and configurations related to the present invention unnecessarily makes the gist of the present invention unclear, the detailed description is omitted.

The present invention provides a rapid blog search apparatus and method in an egocentric blog search environment without having any document data in space of the entire blogs. In the apparatus and method, a rapid blog search is performed by estimating the authority scores of blogs and limiting the number of blogs subjected to an egocentric search to the blogs having high authority scores. That is, the rapid blog search apparatus and method of the present invention estimate the authority scores of blogs by using local information of the blogs (e.g., the number of neighboring blogs linked to a user's blog via trackbacks and the number of neighboring blogs linked to the user's blog via comments), and performs blog search based on the estimated authority scores to search blogs satisfying a given query.

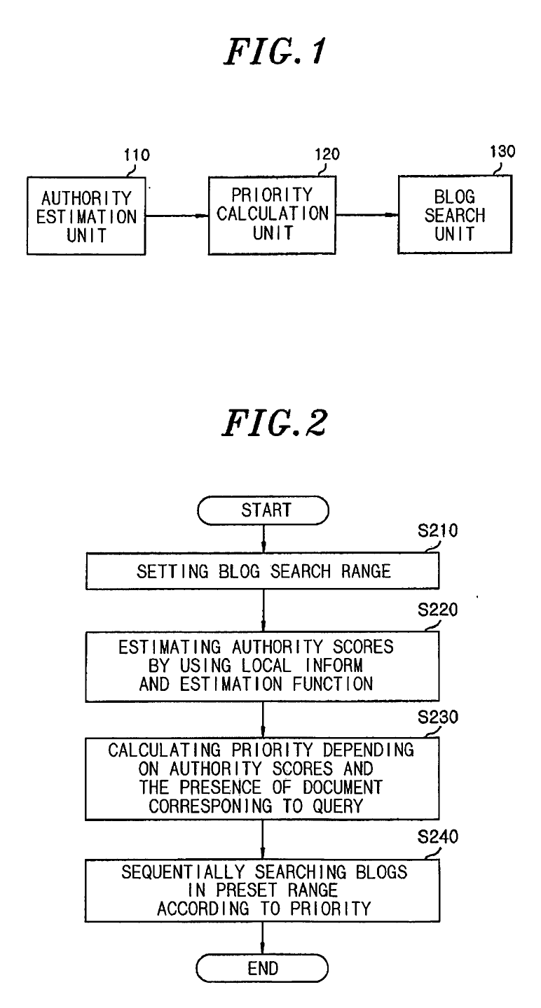

Referring now to FIG. 1, there is shown a block diagram of a blog search apparatus by using blog authority estimation in accordance with an embodiment of the present invention.

As shown in FIG. 1, the blog search apparatus includes an authority estimation unit 110, a priority calculation unit 120, and a blog search unit 130.

The authority estimation unit 110 estimates the authority scores of target blogs to be searched by using local information of the blogs. Herein, the authority scores are estimated by using an estimation function with respect to normalized real authority scores. The estimation function may include a heuristic function. Further, the local information includes either or both of the number of neighboring blogs linked to a user's blog via trackbacks and the number of neighboring blogs linked to the user's blog via comments.

Here, in order to estimate the real authority scores of respective blogs are calculated based on data of whole blogs by using the EigenRumor algorithm, weights are calculated by using linear regression analysis according to the number of neighboring blogs linked via trackbacks and the number of neighboring blogs linked via comments.

The priority calculation unit 120 calculates priorities depending on the authority scores and the presence or absence of documents matching to a query. Herein, when the document matching the query is present in a target blog, a weight greater than 1 is assigned to the authority score of the target blog.

The blog search unit 130 sequentially searches respective target blogs to be searched depending on the priorities of the blogs. According to the present invention, the blog search unit 130 searches target blogs falling within a preset search range from among all the target blogs. The search range is set as either or both of the range of the distance from the user's blog and the range of the number of target blogs to be searched. Furthermore, the blog search unit 130 searches the target blogs falling within the preset range by a greedy search manner sequentially visiting the blogs.

The blog search method performed by the blog search apparatus using blog authority estimation in accordance with the present invention will be described below with reference to FIGS. 2 to 6.

First, the search range for target blogs to be searched is set by the blog search unit 130 at step S210. The search range may be set as either or both of the range of distance from the user's blog and the range of the number of target blogs to be searched. The term ‘range of distance’ refers to a range set by determining how many unit distances need to exist between furthest blogs in the search range when one unit distance is defined by two blogs directly linked to each other by a comment or a trackback. The term ‘range of the number of blogs’ refers to a range set by determining a maximum number of blogs to be searched.

Then, at step S220, the authority estimation unit 110 estimates authority scores by using the local information of the search target blogs to be searched, i.e., the number of neighboring blogs linked via trackbacks and/or the number of neighboring blogs linked via comments. In this case, the authority scores are estimated by using the estimation function with respect to normalized real authority scores.

As described above, the heuristic function is used as the estimation function Further, as the local information, either or both of the number of neighboring blogs linked via trackbacks and the number of neighboring blogs linked via comments may be used. Here, in order to estimate the real authority scores of respective blogs calculated based on data of whole blogs by using the EigenRumor algorithm, weights are calculated and used by using linear regression analysis according to the number of neighboring blogs linked via trackbacks and the number of neighboring blogs linked via comments through linear regression analysis.

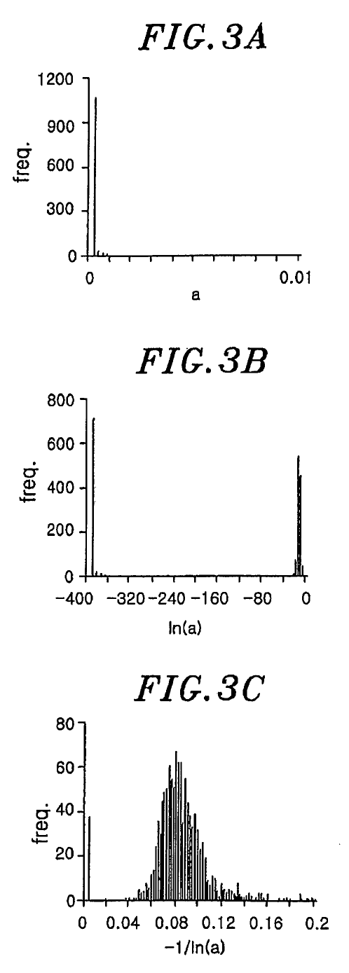

As described above, since the authority scores of blogs and the number of blogs linked by posting trackbacks or comments on a target blog do not conform to normal distribution, they needs to be normalized to calculate the estimation function. FIGS. 3a to 3c are graphs showing the distribution of blog authority scores in the entire blogs when the authority score of a blog is assumed to be ‘a’. FIG. 3A, FIG. 3A and FIG. 3A illustrate the distribution of the authority score ‘a’, the distribution of ln(a), and the distribution of −1/ln(a), respectively.

The following Equation 1 shows a normalization method for respective authority scores, where ‘a’ is an actual authority score of a blog, and ‘na’ is a normalized authority score of the blog.

$$na = - \frac{1}{ln ( a )} \qquad Eq . 1$$

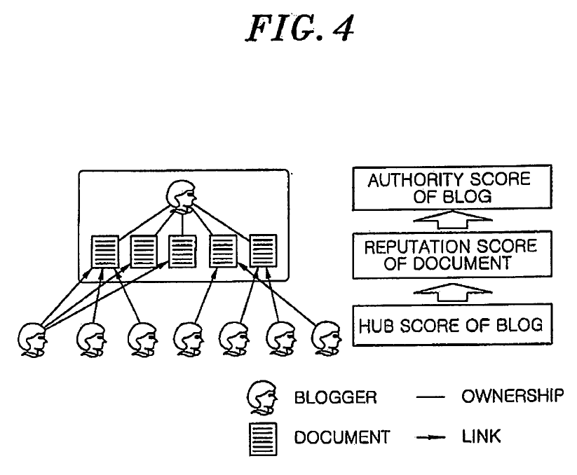

In the EigenRumor algorithm described above, the authority scores of blogs are determined based on the reputation scores of blog documents included in the respective blogs as shown in FIG. 4. Further, the reputation sores of documents are determined based on the hub scores of blogs which are linked by posting trackbacks or comments on the documents. This means that a blog, having more documents linked to a large number of blogs having higher hub scores, has a high authority score.

In the egocentric search, however since all the information of the entire blogs is not known, authority scores needs to be estimated by using only the information the target blog. The number of blogs linked by posting comments or trackbacks on the documents of the target blog affects the calculation of authority scores. Therefore, the authority scores are calculated by the authority estimation function such as Equation 2.

The number of neighboring blogs linked to the target blogs by posting trackbacks and the number of neighboring blogs linked to the target blog by posting comments can be easily detected on a target blog. Therefore, the authority score of the target blog can be estimated even if data of the entire blogs is not known.

In Equation 2, ‘na’ is a normalized value of the estimated authority score of the target blog, n_{c} is the number of neighboring blogs linked by posting comments on the target blog, and nₜ is the number of neighboring blogs linked by posting trackbacks on the target blog.

$$na = \{ \begin{matrix}0 & if {n}_{c} = 0 & and {n}_{t} = 0 \\ {β}_{10} + {β}_{11} \times ln ( {n}_{c} ) & if {n}_{c} > 0 & and {n}_{t} = 0 \\ {β}_{20} + {β}_{21} \times ln ( {n}_{t} ) & if {n}_{c} = 0 & and {n}_{t} > 0 \\ {β}_{30} + {β}_{31} \times ln ( {n}_{c} ) + {β}_{32} \times ln ( {n}_{t} ) & if {n}_{c} > 0 & and {n}_{t} > 0\end{matrix} \qquad Eq . 2$$

Herein, β is a constant indicating weight, β₁₀ and β₁₁ are weights for blogs having comments only, β20 and β₂₁ are weights for blogs having trackbacks only, and β₃₀, β₃₁ and β₃₂ are weights of blogs having both comments and trackbacks.

Herein, in order to estimate the real authority scores of the respective blogs calculated by using the EigenRumor algorithm based on the data of the entire blogs, the weights are calculated through the linear regression analysis, which are shown in Equation 3.

$$na = \{ \begin{matrix}0 & if {n}_{c} = 0 & and {n}_{t} = 0 \\ {β}_{10} + {β}_{11} \times ln ( {n}_{c} ) & if {n}_{c} > 0 & and {n}_{t} = 0 \\ {β}_{20} + {β}_{21} \times ln ( {n}_{t} ) & if {n}_{c} = 0 & and {n}_{t} > 0 \\ {β}_{30} + {β}_{31} \times ln ( {n}_{c} ) + {β}_{32} \times ln ( {n}_{t} ) & if {n}_{c} > 0 & and {n}_{t} > 0\end{matrix} \\ where \\ {β}_{10} = 0.0550743225 \; 46661750 \\ {β}_{20} = 0.0569080675 \; 22265880 \\ {β}_{11} = 0.0550743225 \; 46661750 \\ {β}_{21} = 0.0569080675 \; 22265880 \\ {β}_{30} = 0.0472712233 \; 82443744 \\ {β}_{31} = 0.0159817300 \; 16531526 \\ {β}_{32} = 0.0061723579 \; 51923058 \qquad Eq . 3$$

Then, the priority calculation unit 120 calculates priorities for the target blogs depending on the authority scores and the presence of documents corresponding to the query at step S230. In this case, when a document matching the query is present, a weight greater than 1 is assigned to the authority score of the target blogs. That is, in order to calculate priorities of the target blogs with respect to the user's query, the estimated authority scores of neighboring blogs and the suitability of the target blogs for the query are taken into consideration. A function used to calculate the priorities of the target blogs is shown in Equation 4. In Equation 4, x indicates a target, q indicates the user's query, r is a weight greater than 1, and ha indicates a normalized value of the estimated authority score of the target blog. According to the following Equation 4, a target blog x having a document matching the user's query q has a priority which is r times as high as the normalized authority score ‘hₐ’ of the target blog.

$${h}_{p} ( x , q ) = \{ \begin{matrix}{h}_{a} ( x ) \times γ , & \begin{matrix}only for target blog x having \\ document matching query q\end{matrix} \\ {h}_{a} ( x ) , & \begin{matrix}only for target blog x having \\ no document matching query q\end{matrix}\end{matrix} \qquad Eq . 4$$

Finally, the blog search unit 130 sequentially searches the target blogs set at step S210 based on the priorities. The searches executed by blog search unit 130 are performed on target blogs falling within a preset range by sequentially visiting the target blogs in a greedy search manner at step S240.

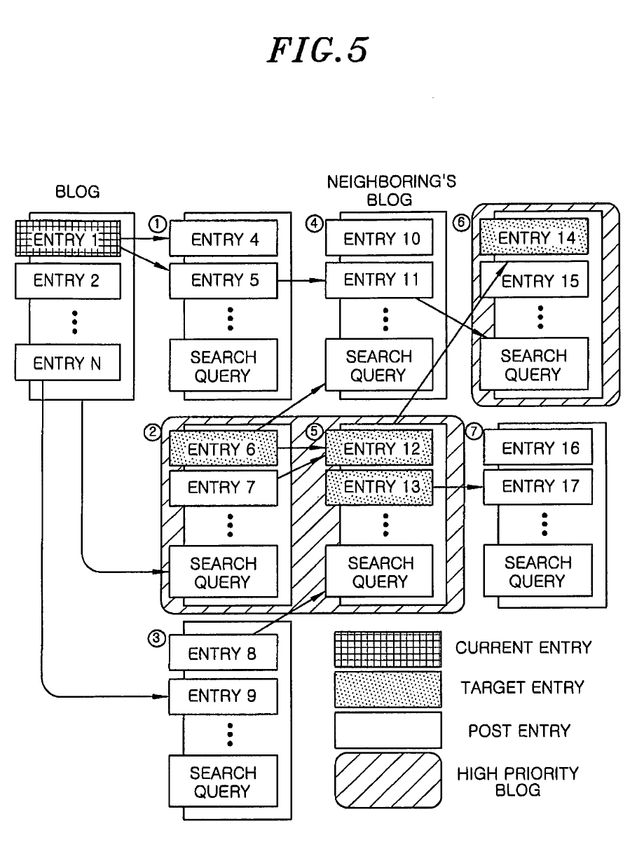

FIG. 5 is a diagram showing a search process performed by the blog search unit 130. In the drawing, a cross striped square, dotted squares and oblique striped squares are an entry of user's blog, entries of target blogs and blogs of high priorities, respectively. In the conventional egocentric blog search, neighboring blogs are sequentially visited and searched in a sequence of \textcircled{1}→\textcircled{2}→\textcircled{3}→\textcircled{4}→\textcircled{5}→\textcircled{6}→\textcircled{7} without considering priorities of target blog. In contrast, in the blog search of the present invention, only those target blogs having higher authority scores, i.e., higher priorities, are visited and searched in a manner that neighboring blogs having high priorities are sequentially visited and searched in a sequence of \textcircled{2}→\textcircled{5}→\textcircled{6}.

The blog search method using the blog authority estimation of the present invention may be implemented as a computer program. Codes and code segments constituting the computer program may be easily derived by computer programmers skilled in the art. Further, such a computer program is stored in a computer-readable storage medium, and is read and executed by a computer, whereby the blog search method using the blog authority estimation can be implemented. The storage medium may be a magnetic recording medium, an optical recording medium, carrier wave medium and the like.

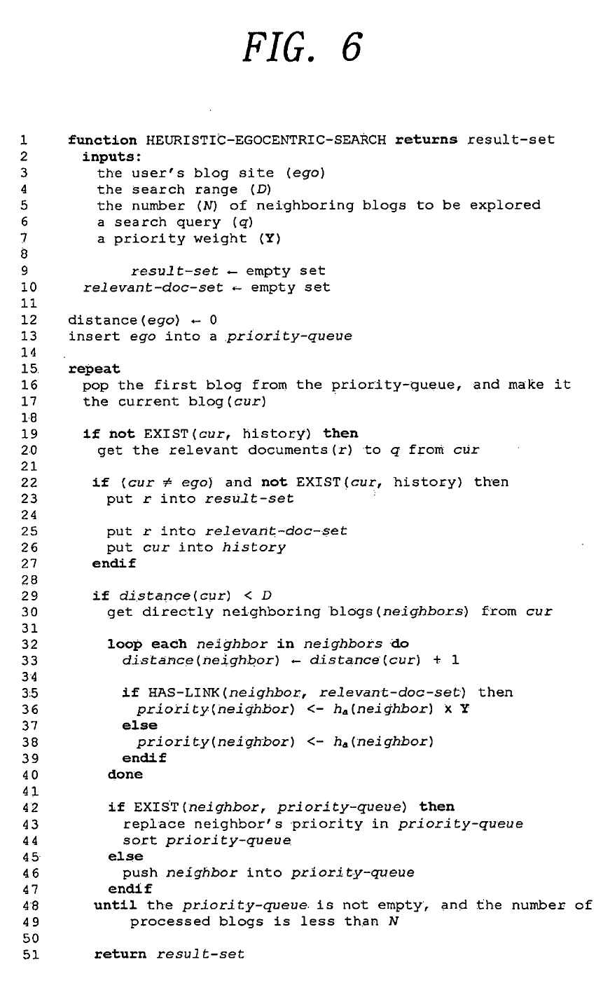

FIG. 6 is an algorithm written to execute the novel blog search method using blog authority estimation on a computer.

In lines 3 to 7, address information on user's blog, the range of search distance, the range of the number of target blogs, a query, and weights are set.

In lines 12 and 13, the user's blog is put in a priority queue.

In lines 16 and 17, a current blog is selected from the priority queue, and documents matching the query are searched for in the current blog.

In lines 19 to 27, searched documents are stored as the results of the search, and whether or not the distance between the user's blog and the current blog falls within the range of search distance is determined.

In lines 30 to 47, if it is determined that the current blog falls within the range of search distance, neighboring blogs of the current blog are put in the priority queue. The priorities of the neighboring blogs are calculated by Equation 4.

The process in lines 16 to 47 is repeated times corresponding to the range of a designated search space, i.e., the number of target blogs) set in line 5.

In accordance with the present invention, there is an advantage in that, when important documents within the neighboring blogs to a user's blog are egocentrically searched, the authority scores of the neighboring blogs are estimated, and some of neighboring blogs having high authority scores are primarily searched. Accordingly, the search space is narrowed to relatively important blogs among all neighboring blogs so that a temporal overhead required to find important documents can be reduced, thereby improving the speed of blog searching.

While the invention has been shown and described with respect to the embodiments, it will be understood by those skilled in the art that various changes and modification may be made without departing from the scope of the invention as defined in the following claims.

What is claimed is:

1. A blog search method comprising:
estimating authority scores of target blogs to be searched by using local information about the target blogs;
calculating priorities of the target blogs based on the authority scores and the presence of documents satisfying a query; and
sequentially searching the target blogs based on the priorities.

2. The blog search method of claim 1, wherein, in said estimating the authority scores, the authority scores are estimated by using an estimation function with respect to normalized real authority scores.

3. The blog search method of claim 2, wherein the estimation function includes a heuristic function.

4. The blog search method of claim 1, wherein the local information includes at least one of the number of neighboring blogs linked via trackbacks and the number of neighboring blogs linked via comments.

5. The blog search method of claim 4, wherein, in said estimating the authority scores, in order to estimate authority scores of the target blogs calculated based on data of all target blogs by using an EigenRumor algorithm, weights are calculated and used depending on the number of neighboring blogs linked via trackbacks and the number of neighboring blogs linked via comments through linear regression analysis.

6. The blog search method of claim 1, wherein said calculating the priorities includes assigning weights to the relevant authority scores when a document satisfying the query is present.

7. The blog search method of claim 1, wherein said sequentially searching the target blogs includes searching blogs falling within a preset search range from among all the target blogs.

8. The blog search method of claim 7, wherein the preset search range is at least one of a range of distance from a user's blog and a range of the number of blogs to be searched.

9. The blog search method of claim 7, wherein the target blogs falling within the preset search range are searched by sequentially visiting the target blogs in a greedy search manner.

10. A blog search apparatus comprising:
an authority estimation unit for estimating authority scores of target blogs to be searched by using local information about the blogs;
a priority calculation unit for calculating priorities depending on the authority scores and the presence of documents satisfying a query; and
a blog search unit for sequentially searching the target blogs based on the priorities.

11. The blog search apparatus of claim 10, wherein the authority estimation unit estimates the authority scores by using an estimation function with respect to normalized real authority scores.

12. The blog search apparatus of claim 11, wherein the estimation function includes a heuristic function.

13. The blog search apparatus of claim 10, wherein the local information includes at least one of the number of neighboring blogs linked via trackbacks and the number of neighboring blogs linked via comments as the local information.

14. The blog search apparatus of claim 13, wherein, in the authority estimation unit, in order to estimate authority scores of the target blogs calculated based on data of all blogs by using an EigenRumor algorithm, weights are calculated and used depending on the number of neighboring blogs linked via trackbacks and the number of neighboring blogs linked via comments through linear regression analysis.

15. The blog search apparatus of claim 10, wherein the priority calculation unit assigns weights to the authority scores when a document satisfying the query is present.

16. The blog search apparatus of claim 10, wherein the blog search unit searches blogs falling within a preset search range from among all the target blogs.

17. The blog search apparatus of claim 16, wherein the preset search range is at least one of a range of distance from a user's blog and a range of the number of blogs to be searched.

18. The blog search apparatus of claim 16, wherein the blog search unit searches the blogs falling within the preset search range by sequentially visiting the blogs in a greedy search manner.
